(19) United States
(12) Patent Application Publication
(10) Pub. No.: US 2017/0118944 A1
(43) Pub. Date: May 4, 2017

(54) DISPOSABLE LITTER BOXES AND METHODS OF PROVIDING AND USING SUCH LITTER BOXES

(71) Applicant: NESTEC SA, Vevey (CH)

(72) Inventors: Stephen A. Wurth, St. Louis, MO (US); Adam M. Hobler, St. Louis, MO (US); Nathan Foster Huck, Jackson, MO (US); Ronald Bailey, Pacific, MO (US)

(21) Appl. No.: 15/333,602

(22) Filed: Oct. 25, 2016

Related U.S. Application Data
(60) Provisional application No. 62/247,583, filed on Oct. 28, 2015.

(51) Int. Cl. A01K 1/01

(52) U.S. Cl. CPC A01K 1/0107

(57) ABSTRACT

Litter boxes are provided that have a tear-away flap on the top and/or the front of the box. The tear-away flap can be pulled outward from the box to form a mat that can provide an entry to the box. Positioning the tear-away flap as a mat can expose a corrugate fluting structure on the tear-away flap. This structure can act as an anti-tracking trap as the cat leaves the box with litter on the paws. An overhang on one or more sides of the box (preferably three sides) can prevent litter from “splashing” out of the box onto the floor. After the pet owner is finished using the litter box, the pet owner can fold the tear-away flap back onto the top of the box to reseal the box to keep the litter in the box for disposal.

### CROSS REFERENCE TO RELATED APPLICATIONS

This application claims priority to U.S. Provisional Application No. 62/247,583 filed Oct. 28, 2015, the disclosure of which is incorporated herein by this reference.

### BACKGROUND

The present disclosure relates generally to litter boxes and particularly to disposable litter boxes easily accessible by a pet. More specifically, the present disclosure is directed to litter boxes having a tear-away flap on the top and/or the front of the box.

Management of animal waste is a consequence of maintaining a domestic animal in the home. To address this issue, litter boxes containing suitable particulate litters are employed so that pets such as cats use the litter box for elimination of urine and fecal matter. A litter box contains a layer of pet litter that receives the urine and fecal matter, and several problems are associated with known litter boxes and how they are usually purchased.

A pet owner typically purchases the litter box and the litter at a retail location, which can be a time consuming and laborious task. Furthermore, the filling of traditional litter boxes requires the user to pour litter into the box, which can create nuisance dust and ergonomic strain on the user.

The pet litter is absorbent granules, which are often tracked out of the litter box onto the surrounding floor by the cat. Then the user must take time to sweep these granules. Moreover, open (non-hooded) litter boxes can allow for litter to be ejected due to the digging activity of the cat during use and thus position even more granules outside of the box that need to be cleaned. Hooded boxes can prevent this granule ejection to some degree, but they can concentrate malodor in a confined space, which is typically not well-tolerated by the cat and thus do not present a desirable solution.

Typical maintenance of a litter box includes periodic cleaning/washing of the box itself. Furthermore, users may be forced to clean the box in areas of the home which are undesirable to expose to cat waste (kitchen, bathtub, etc.). This cleaning can be a messy and time consuming process.

Most of the current odor control strategies in the litter box rely on strong fragrance applications prior to litter packaging and/or after litter box use, for example by spraying deodorant around the box. The litter loses fragrance over duration of storage or after opening the container containing the deodorant. This loss of fragrance detrimentally impacts the effectiveness of the deodorant. Also, the amount or intensity of the litter fragrance may not be sufficient for the tastes of some pet owners.

### SUMMARY

The present disclosure relates to litter boxes that can have a corrugate box design with a tear-away flap on the top and/or the front of the box. The boxes can comprise an easy-pull tear strip that can be removed to expose the tear-away flap. The tear-away flap can then be pulled outward from the box to form a mat that can provide an entry to the box. For example, one or more sides of the tear-away flap can be disconnected from the remainder of the box.

Positioning the tear-away flap as a mat can expose a corrugate fluting structure on the tear-away flap. This structure can act as an anti-tracking trap as the cat leaves the box with litter on the paws. An overhang on one or more sides of the box (preferably three sides) can prevent litter from “splashing” out of the box onto the floor.

The tear-away flap can comprise a tuck flap that slides under the box such that the weight of the product in the box holds the tuck flap down, thereby keeping the tear-away flap in place as a mat. Additionally or alternatively, the tear-away flap can comprise an adhesive that attaches to the adjacent side of the box to keep the tear-away flap in place as a mat.

After the pet owner is finished using the litter box, the pet owner can remove a backing from an adhesive tear strip pre-applied on the inner rim of the tear-away flap, fold the tear-away flap back onto the top of the box, and reseal the box to keep the litter in the box for disposal of the box and contents. Additionally of alternatively, at least part of the tear-away flap can insert under a back ledge to reseal the box.

Accordingly, in a general embodiment, the present disclosure provides a litter box comprising: a top wall and a bottom wall; side walls extending between the top wall and the bottom wall such that the top, bottom and side walls form an interior; pet litter enclosed in the interior; and a first flap comprising a first portion formed by at least part of the top wall, the first flap arranged in the litter box in a closed position and configured to move to an open position in which the pet litter is accessible, and the first portion of the first flap is approximately coplanar with the bottom wall in the open position. The litter box can comprise an anti-tracking structure on the first portion of the first flap, the anti-tracking structure comprising ridges extending upward from the first portion of the first flap in the open position.

In another embodiment provided by the present disclosure, a method of managing pet waste is provided. The method comprises: placing a litter box in a desired location, the litter box comprising a top wall, a bottom wall, and side walls extending between the top wall and the bottom wall such that the top, bottom and side walls form an interior in which pet litter is enclosed; and moving a first flap of the litter box from a closed position to an open position in which the pet litter is accessible, the first flap comprises a first portion formed by at least part of the top wall, and the moving of the first flap to the open position comprises moving the first portion of the first flap to be approximately coplanar with the bottom wall. The method can comprise ordering the litter box using an internet webpage and then receiving the litter box with the pet litter enclosed in the interior of the litter box, and the placing of the litter box in the desired location is performed after receipt of the litter box.

In yet another embodiment provided by the present disclosure, a method of providing a litter box is provided. The method comprises: receiving an order for the litter box from an individual through an internet webpage; and sending the litter box to the individual with pet litter enclosed in the litter box, the litter box comprising a top wall, a bottom wall, and side walls extending between the top wall and the bottom wall such that the top, bottom and side walls form an interior in which pet litter is enclosed, and the litter box comprises a first flap comprising a first portion formed by at least part of the top wall, the first flap arranged in the litter box in a closed position and configured to move to an open position in which the pet litter is accessible, and the first portion of the first flap is approximately coplanar with the bottom wall in the open position

An advantage of one or more embodiments disclosed herein is to provide improved pet litter boxes.

Another advantage of one or more embodiments disclosed herein is to provide improved methods of supplying pet litter boxes to consumers.

A further advantage of one or more embodiments disclosed herein is to ship a pre-filled litter box directly to the user's home through an e-commerce channel so a trip to a retail store is unnecessary.

Still another advantage of one or more embodiments disclosed herein is to provide a pet litter box pre-filled with litter so the user does not need to pour litter.

Yet another advantage of one or more embodiments disclosed herein is to provide a pet litter box that incorporates a built-in anti-tracking feature so litter granules are not tracked by the pet onto the surrounding floor.

Another advantage of one or more embodiments disclosed herein is to provide a pet litter box having a ledge that minimizes ejection of litter while maintaining an open and more appealing environment for the cat.

A further advantage of one or more embodiments disclosed herein is to provide a disposable pet litter box that thus never needs to be cleaned.

Still another advantage of one or more embodiments disclosed herein is to provide a pet litter box having a liquid repellant coating which protects the material of the box throughout the life of the box and litter therein.

Yet another advantage of one or more embodiments disclosed herein is to provide a pet litter box having a component that maintains full fragrance freshness and efficacy and only releases an aroma or odor control element upon activation by the user.

Another advantage of one or more embodiments disclosed herein is to provide a pet litter box having a component that supplements the fragrance of the litter thereby enhancing odor control.

Additional features and advantages are described herein and will be apparent from the following Detailed Description and the Figures.

### BRIEF DESCRIPTION OF THE FIGURES

FIG. 1 is a perspective view of an embodiment of a litter box according to the present disclosure, with the tear-away flap in the closed position.

FIG. 2 is a perspective view of an embodiment of a litter box according to the present disclosure, with the tear-away flap in the open position and with litter therein.

FIG. 3 is a perspective view of an embodiment of a litter box according to the present disclosure, with the tear-away flap in the open position and without litter therein.

### DETAILED DESCRIPTION

As used in this disclosure and the appended claims, the singular forms “a,” “an” and “the” include plural referents unless the context clearly dictates otherwise. Thus, for example, reference to “a material” or “the material” includes two or more materials.

The words “comprise,” “comprises” and “comprising” are to be interpreted inclusively rather than exclusively. Likewise, the terms “include,” “including” and “or” should all be construed to be inclusive, unless such a construction is clearly prohibited from the context.

However, the devices disclosed herein may lack any element that is not specifically disclosed. Thus, a disclosure of an embodiment using the term “comprising” includes a disclosure of embodiments “consisting essentially of” and “consisting of” the components identified. Similarly, the methods disclosed herein may lack any step that is not specifically disclosed herein. Thus, a disclosure of an embodiment using the term “comprising” includes a disclosure of embodiments “consisting essentially of” and “consisting of” the steps identified.

The term “and/or” used in the context of “X and/or Y” should be interpreted as “X,” or “Y,” or “X and Y.” Where used herein, the terms “example” and “such as,” particularly when followed by a listing of terms, are merely exemplary and illustrative and should not be deemed to be exclusive or comprehensive. Any embodiment disclosed herein can be combined with any other embodiment disclosed herein unless explicitly stated otherwise.

All percentages expressed herein are by weight of the total weight of the composition unless expressed otherwise. As used herein, “about” and “approximately” are understood to refer to numbers in a range of numerals, for example the range of −10% to +10% of the referenced number, preferably within −5% to +5% of the referenced number, more preferably within −1% to +1% of the referenced number, most preferably within −0.1% to +0.1% of the referenced number. Further in this regard, a component that is “approximately coplanar” or “approximately parallel” to another component has an angle that is within the above-disclosed ranges relative to the angle of the other component. Similarly, a component that is “approximately perpendicular” to another component has an angle that is within the above-disclosed ranges relative to the sum of the angle of the other component and 90 degrees.

All numerical ranges herein should be understood to include all integers, whole or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

Numerical adjectives, such as “first” and “second,” are merely used to distinguish components. These numerical adjectives do not imply the presence of other components, a relative positioning, or any chronological implementation. In this regard, the presence of a “second portion” does not imply that a “first portion” is necessarily present. Further in this regard, a “second flap” can be used before, after, or simultaneously with any “first flap.”

The terms “pet” and “animal” are used synonymously herein and mean any animal which can use a litter box, non-limiting examples of which include a cat, a dog, a rat, a ferret, a hamster, a rabbit, an iguana, a pig or a bird. The pet can be any suitable animal, and the present disclosure is not limited to a specific pet animal. The term “elimination” means urination and/or defecation by a pet.

The methods and devices and other advances disclosed herein are not limited to particular methodologies, protocols, and reagents because, as the skilled artisan will appreciate, they may vary. Further, the terminology used herein is for the purpose of describing particular embodiments only and does not limit the scope of that which is disclosed or claimed.

Unless defined otherwise, all technical and scientific terms, terms of art, and acronyms used herein have the meanings commonly understood by one of ordinary skill in the art in the field(s) of the present disclosure or in the field(s) where the term is used. Although any compositions, methods, articles of manufacture, or other means or materials similar or equivalent to those described herein can be used, the preferred devices, methods, articles of manufacture, or other means or materials are described herein.

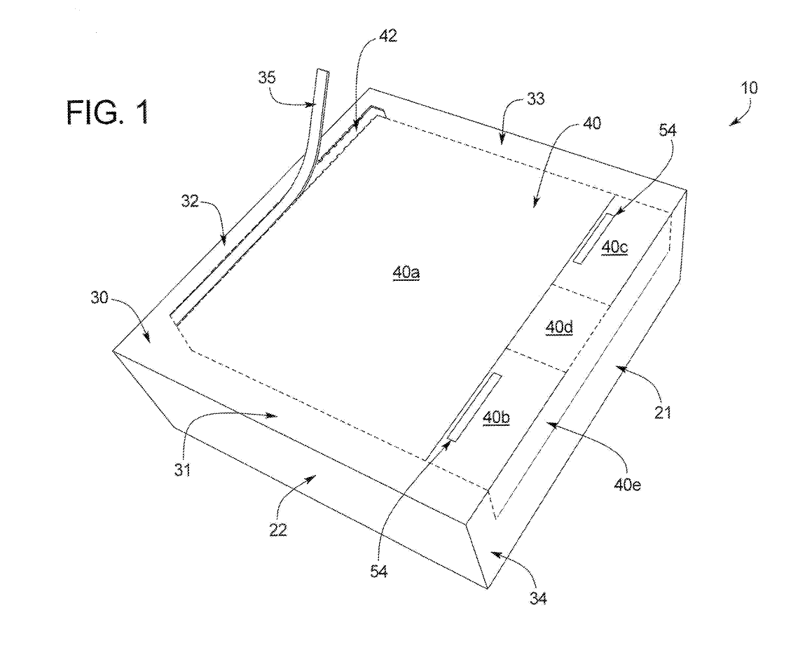

FIGS. 1-3 generally illustrate a non-limiting embodiment of a litter box 10. For example, the litter box 10 can comprise a bottom wall 20 and a top wall 30 that are approximately parallel to each other. Preferably the bottom wall 20 and the top wall 30 are approximately the same size and/or the same shape.

The litter box 10 can comprise side walls, for example a front wall 21, a left wall 22, a right wall 23, and a back wall 24, each of which can be approximately perpendicular to the bottom wall 20 and/or the top wall 30. The top wall 30, the bottom wall 20, and the side walls (e.g., the front wall 21, the left wall 22, the right wall 23, and/or the back wall 24) can form an interior configured to hold pet litter 100 and enclose (preferably completely enclose) the pet litter 100. Preferably the side walls (e.g., the front wall 21, the left wall 22, the right wall 23, and/or the back wall 24) do not extend beyond the bottom wall 20 or the top wall 30; for example, the height of each of the side walls is preferably approximately equal to the distance of the bottom wall 20 from the top wall 30.

Preferably one or more of the bottom wall 20, the top wall 30, the front wall 21, the left wall 22, the right wall 23, and the back wall 24 are made of paperboard (e.g., containerboard such as fiberboard, for example corrugated fiberboard) such that the litter box 10 is disposable.

All directions used herein, such as “front,” “back,” “left,” “right,” “top,” “bottom,” “upward,” “downward,” “vertical” and “horizontal” refer to the relative directions that would be perceived by a user viewing the litter box 10 with the front wall 21 being the wall closest to the user, the back wall 24 being the wall farthest from the user, and the bottom wall 20 of the litter box 10 resting on a horizontal surface supporting the weight of the litter box 10.

The figures depict the litter box 10 as a square box such that the front wall 21, the left wall 22, the right wall 23, and the back wall 24 are approximately the same size and/or the same shape. Nevertheless, the litter box 10 can have any shape, such as rectangular, polygonal or circular; and the litter box 10 is not limited to a specific shape. Further in this regard, the litter box 10 is not limited to a specific number of walls or configuration of walls; for example, the litter box 10 can have any number of side walls, top walls, and bottom walls.

The litter box 10 is preferably sized to accommodate a cat; for example, the litter box 10 can have a height of about at least about six inches. Nevertheless, the litter box 10 is not limited to any specific dimensions.

The top wall 30 can comprise one or more of a left section 31, a back section 32 and a right section 33. Preferably the left, back and right sections 31-33 of the top wall 30 are approximately coplanar with each other.

The litter box 10 can comprise a first flap 40 that can function as a tear-away flap. For example, the top wall 30 and/or the front wall 21 can form at least a portion of the first flap 40. In a preferred embodiment, a portion of the first flap 40 forms part of the top wall 30, and another portion of the first flap 40 forms part of the front wall 21.

For example, the first flap 40 can comprise one or more of a first portion 40a, a second portion 40b, a third portion 40c, a fourth portion 40d, and a fifth portion 40e. As shown in FIG. 1, when the first flap 40 is closed, at least part of the outer surface of the front wall 21 can be formed by a body section 34 of the front wall 21 and the fifth portion 40e of the first flap 40. In an embodiment, the outer surface of the front wall 21 consists of the outer surface of the body section 34 of the front wall 21 and the outer surface of the fifth portion 40e of the first flap 40. Preferably, the body section 34 of the front wall 21 and the fifth portion 40e of the first flap 40 are approximately coplanar with each other when the first flap 40 is closed.

As further shown in FIG. 1, when the first flap 40 is closed, at least part of the outer surface of the top wall 30 can be formed by the left, back and right sections 31-33 of the top wall 30 and the first, second, third, and fourth portions 40a-d of the first flap 40. Preferably, the left, back and right sections 31-33 of the top wall 30 are approximately coplanar with each of the first, second, third, and fourth portions 40a-d of the first flap 40 when the first flap 40 is closed, as shown in FIG. 1.

Lines of weakness (shown in FIG. 1 by dashed lines) can be positioned between one or more sides of the first flap 40 and other sections of the litter box 10. Non-limiting examples of lines of weakness include perforations, score lines, and combinations thereof.

As shown in FIG. 1, the litter box 10 can comprise a removable strip 35. The removable strip 35 can be a part of the top wall 30 of the litter box. For example, the removable strip 35 can be connected to the back section 32 of the top wall 30 and the first portion 40a of the first flap 40 by lines of weakness, preferably approximately parallel lines of weakness along the length of the removable strip 35. In an embodiment, the removable strip 35 comprises reinforced oriented polypropylene (OPP) adhesive-backed tape.

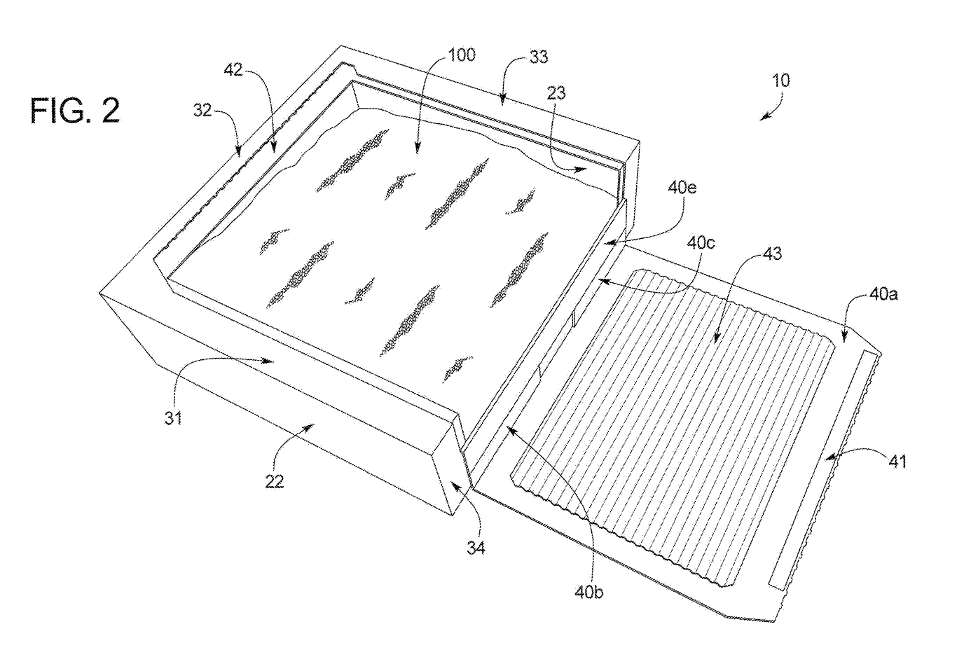

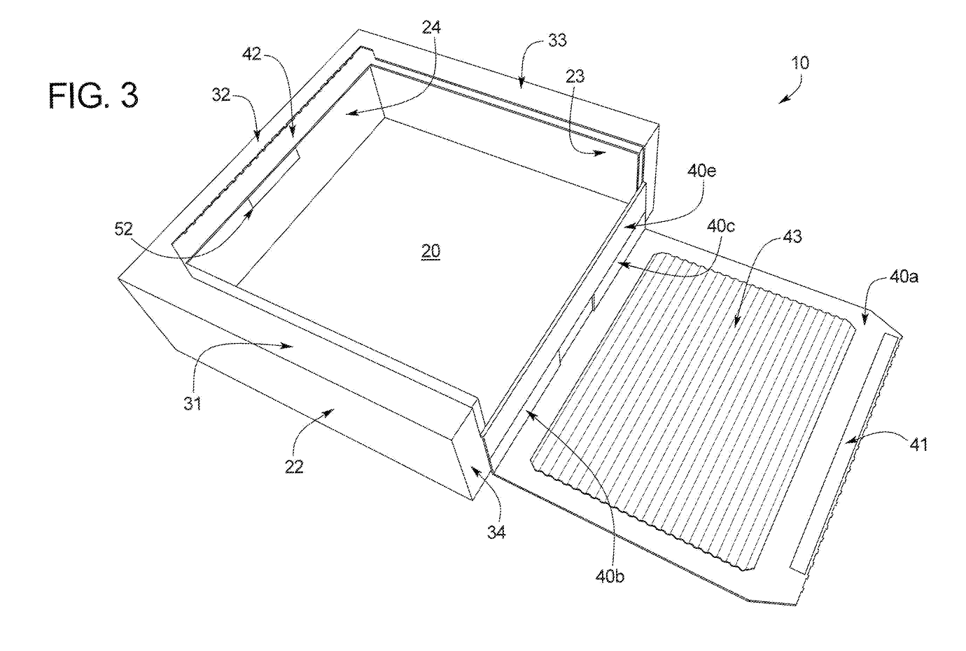

At least one end of the removable strip 35 can be accessible to the pet owner such that the pet owner can pull the removable strip 35 to detach the removable strip 35 from the litter box 10, for example from the top wall 30. Detachment of the removable strip 35 from the litter box 10 can enable the first flap 40 to be moved from the closed position (FIG. 1) to the open position (FIGS. 2 and 3), as discussed in greater detail later herein.

As shown in FIG. 1, when the first flap 40 is closed, at least part of the outer surface of the front wall 21 can be formed by the removable strip 35; the left, back and right sections 31-33 of the top wall 30; and the first, second, third, and fourth portions 40a-d of the first flap 40. In an embodiment, the outer surface of the top wall 30 consists of the outer surface of the removable strip 35; the outer surfaces of the left, back and right sections 31-33 of the top wall 30; and the outer surfaces of the first, second, third, and fourth portions 40a-d of the first flap 40.

In an embodiment, a left side of the first portion 40a of the first flap 40 is connected to the left section 31 of the top wall 30 by a line of weakness; a back side of the first portion 40a of the first flap 40 is connected to the removable strip 35 and/or the back section 32 of the top wall 30 by another line of weakness; and a right side of the first portion 40a of the first flap 40 is connected to the right section 33 of the top wall 30 by yet another line of weakness. In such an embodiment, a front side of the first portion 40a of the first flap 40 is preferably integral with one or more of the second, third and fourth portions 40b-d of the first flap 40 and does not have a line of weakness therebetween.

A left side of the second portion 40b of the first flap 40 can be connected to the left section 31 of the top wall 30 by a line of weakness, and a right side of the second portion 40b of the first flap 40 can be connected to the fourth portion 40d of the first flap 40 by another line of weakness. In an embodiment, a left side of the third portion 40c of the first flap 40 is connected to the fourth portion 40d of the first flap 40 by a line of weakness, and a right side of the third portion 40c of the first flap 40 is connected to the right section 33 of the top wall 30 by another line of weakness.

In such embodiments, a front side of the second portion 40b of the first flap 40 and/or a front side of the third portion 40c of the first flap 30 are preferably integral with the fifth portion 40e of the first flap 40 and do not have a line of weakness therebetween. The front side of the fourth portion 40d of the first flap 30 is preferably connected to the fifth portion 40e of the first flap 40 by a line of weakness.

A left side and a right side of the fifth portion 40e of the first flap 40 can each be respectively connected by lines of weakness to the body section 34 of the front wall 21. A bottom side of the fifth portion 40e of the first flap 40 can be integral with the body section 34 of the front wall 21 and does not have a line of weakness therebetween.

As shown in FIGS. 2 and 3, the first flap 40 can be moved to the open position to provide access to the pet litter 100 within the litter box 10. For example, the pet owner can pull the first flap 40 from the other sections of the top wall 30 and/or the other sections of the front wall 21 to break the corresponding lines of weakness. Further in this regard, the “back side” of the first flap 40, namely the side connected to the back section 32 (i.e., the side of the first flap 40 adjacent to the back wall 24) (FIG. 1) can become the “front side” of the first flap 40, namely the side of the first flap 40 farthest from the back wall 24 and positioned in front of the front wall 21 (FIGS. 2 and 3).

Preferably the litter box 10 is provided to the pet owner with the pet litter 100 already in the litter box 10. In this regard, FIG. 3 is presented merely to show the interior of the litter box 10 without the pet litter 100 therein, and typically the litter box 10 is not provided or used without the pet litter 100 therein. Of course, when the litter box 10 is provided to the pet owner, the pet litter 100 has not been used yet and thus does not contain animal waste.

In an embodiment, the first flap 40 is moved from the closed position (FIG. 1) to the open position (FIG. 2) by (i) detaching the removable strip 35; (ii) then pulling the first portion 40a apart from the left, back and right sections 31-33 of the top wall 30; (iii) pulling the second portion 40b apart from the left section 31 of the top wall 30 and pulling the third portion 40c apart from the right section 33 of the top wall 30, during and/or after the pulling of the first portion 40a; (iv) and pulling the left and right sides of the fifth portion 40e apart from the body section 34 of the front wall 21.

Preferably, the first flap 40 is moved to the open position by grasping the back side of the first portion 40a and pulling the back side of the first portion 40a toward the area in front of the front wall 20 to change this side of the first portion 40a to the front side of the first portion 40a. For example, steps (ii) and (iii) disclosed in the preceding paragraph can comprise pivoting the first portion 40a on an axis formed by the top edge of the front wall 21. Step (iv) can comprise pivoting the fifth portion 40e on an axis formed by the bottom edge of the fifth portion 40e (e.g., the horizontal edge where the fifth portion 40e meets the body section 34). Preferably, at least the first, second, third and fifth portions 40a-c,40e remain connected to each other throughout the moving to the open position and also afterward, and preferably the fourth portion 40d remains connected to at least the first portion 40a throughout the moving to the open position and also afterward.

As shown in FIG. 2, moving the first flap 40 to the open position can comprise moving the fifth portion 40e of the first flap 40 adjacent to and preferably into abutment with the body section 34 of the front wall 21. The second and third portions 40b,40c can also be moved adjacent to and preferably into abutment with the body section 34 of the front wall 21. As a result, the second, third and fifth portions 40b,40c,40e can be approximately parallel to the body section 34 of the front wall 21.

The litter box 10 can be placed on an approximately flat surface before, during and/or after the opening on the first flap 40. For example, the litter box 10 can be placed on the floor of a home or other building where a pet such as a cat resides. The surface can support the bottom wall 20 of the litter box 10. When the first flap 40 is opened, the first portion 40a of the first flap 40 can be positioned on the surface. For example, the first portion 40a of the first flap 40 can be approximately coplanar with the bottom wall 20 of the litter box 10. The first portion 40a of the first flap 40 can thus form an entry mat for the litter box 10 which has been opened and in which the pet litter 100 is accessible.

In a preferred embodiment, the first portion 40a of the first flap 40 in the open position (FIG. 2) and the first portion 40a of the first flap 40 in the closed position (FIG. 1) extend from the front wall 21 of the litter box 10 in approximately opposite horizontal directions relative to each other. The first portion 40a of the first flap 40 in the open position (FIG. 2) and the first portion 40a of the first flap 40 in the closed position (FIG. 1) can extend from the front wall 21 of the litter box 10 in approximately parallel horizontal planes relative to each other, preferably with the first portion 40a of the first flap 40 in the open position in a lower horizontal plane (i.e., closer to the bottom wall 20) relative to the first portion 40a of the first flap 40 in the closed position.

Further in this regard, the fifth portion 40e of the first flap 40 in the open position (FIG. 2) and the fifth portion 40e of the first flap 40 in the closed position (FIG. 1) can extend from the body section 34 of the front wall 21 in approximately opposite vertical directions relative to each other but in the same vertical plane. The second and third portions 40b,40c of the first flap 40 in the open position can be approximately coplanar with the fifth portion 40e of the first flap 40 (FIG. 2), and the second and third portions 40b,40c of the first flap 40 in the closed position can be approximately perpendicular to the fifth portion 40e of the first flap 40 in the closed position (FIG. 1).

When the pet litter 100 in the litter box 10 is used by the pet, the pet may dig in the pet litter 100 before, during and/or after elimination and thus may splash a portion of the pet litter 100 outward and/or upward. However, the left section 31 of the top wall 30 preferably extends inward from the left wall 21 toward the top of the right wall 23, the back section 32 of the top wall 30 preferably extends inward from the back wall 24 toward the top of the front wall 21, and the right section 33 of the top wall 30 preferably extends inward from the right wall 23 toward the top of the left wall 21. Each of the left, back and right sections 31-33 of the top wall 30 can thereby form an overhang that prevents the splashed portion of the pet litter 100 from exiting the litter box 10 or minimizes the amount of the splashed portion of the pet litter 100 that exits the litter box 10.

The first portion 40a of the first flap 40 can comprise an anti-tracking structure 43 that can remove any of the pet litter 100 that is positioned on the feet of the pet (e.g., the paws of a cat) when the pet exits the interior of the litter box 10 onto the first portion 40a of the first flap 40. For example, the anti-tracking structure 43 can comprise a corrugated structure extending upward from the first portion 40a of the first flap 40 in the open position, i.e., a series of parallel furrows and ridges. Preferably, the anti-tracking structure 43 is positioned in the interior of the box 10 when the first flap 40 is in the closed position.

A particularly preferred embodiment of the anti-tracking structure 43 is exposed C-flute single face corrugated fiberboard. Nevertheless, the present disclosure is not limited to a specific embodiment of the anti-tracking structure 43, and the anti-tracking structure 43 can be any component of the first flap 40 that makes the first portion 40a of the first flap 40 have uneven surfaces exposed thereon to clean the paws of the pet as the pet exits the interior of the litter box 10.

The fourth portion 40d of the first flap 40 can form a second flap that can function as a tuck flap. In such an embodiment, the pet owner can separate the fourth portion 40d of the first flap 40 from the second, third and fifth portions 40b,40c,40e of the first flap 40. The fourth portion 40d of the first flap 40 preferably remains connected to the first portion 40a. The fourth portion 40d of the first flap 40 can extend from the first portion 40a of the first flap 40 to maintain a position of the first portion 40a of the first flap 40.

For example, the fourth portion 40d of the first flap 40 can be inserted between the bottom wall 20 and the surface under the bottom wall 20, and the weight of the pet litter 100 can maintain the fourth portion 40d of the first flap 40 in this inserted position. In turn, the position of the first portion 40a can be maintained because the fourth portion 40d is connected to the first portion 40a. Therefore, the fourth portion 40d can maintain a position of the first portion 40a approximately co-planar with the bottom wall 20 of the litter box 10 (e.g., on the surface).

Additionally or alternatively to the fourth portion 40d of the first flap 40 functioning as a tuck flap to maintain the open position of the first portion 40a, the first flap 40 can comprise an adhesive strip 54 (e.g., a hot melt adhesive) to maintain the open position of the first portion 40a. For example, one or more of the second, third, fourth and fifth portions 40b-40e can have the adhesive strip 54 thereon. Additionally or alternatively, the adhesive strip 54 for maintaining the open position of the first portion 40a can be provided on the body section 34 of the first wall 21.

The adhesive strip 54 for maintaining the open position can attach the corresponding portion of the first flap 40 to the body section 34 of the first wall 21, for example when the corresponding portion is placed in abutment with the body section 34 of the first wall 21. In turn, the position of the first portion 40a can be maintained because the first portion 40a is directly or indirectly connected to the one or more portions attached by the adhesive strip 54 to the body section 34 of the first wall 21. In a preferred embodiment, the litter box 10 is provided with a cover positioned over this adhesive strip 54, and the pet owner removes the cover to expose the adhesive strip 54 before and/or during the moving of the first flap 40 from the closed position to the open position.

In an embodiment, the litter box 10 comprises a user-activated aroma/malodor counteractant strip 52, preferably in the interior of the litter box 10 above the pet litter 100. The user-activated aroma/malodor counteractant strip 52 can release an aroma or odor control element upon activation by the pet owner. The user-activated aroma/malodor counteractant strip 52 can supplement the fragrance of the pet litter 100 thereby enhancing odor control. In an embodiment, the user-activated aroma/malodor counteractant strip 52 can comprise a peelable cover overlaying a fragrance-infused adhesive and/or another fragrance-carrying media such as a wax or a gel that is exposed when the cover is removed.

Non-limiting examples of odor control agents/odor inhibitors suitable for the user-activated aroma/malodor counteractant strip 52 include chlorinated oxidizers (e.g., chlorine dioxide), aldehydes, permanganates, peroxides, metal oxides, borates, borax, perborates, enzymes, urease inhibitors, proteases, cationic surfactants (e.g., N-ethyl-N-soyamorpholiniumetho sulphate), metallic salts including zinc salts, zinc ricinoleate, zinc chloride, zinc gluconate, metal ions including transition metal ions, nano-particulate metal ions including ferric and aluminum salts, silver, copper, zinc, carbon (e.g., activated), oxides, cyclodextrins, zeoloites, activated carbon, activated alumina, calcium carbonate, silicas, clay minerals, chlorophyll, metal organic frameworks (MOFs), molecular sieves, chelating agents, photocatalysts, and metal binders such as ethylenediaminetetraacetic acid (EDTA). Non-limiting examples of fragrance compositions suitable for the user-activated aroma/malodor counteractant strip 52 include one or more esters, linear terpenes, cyclic terpenes, aromatics, amines, alcohols, aldehydes, esters, ketones, lactones, thiols. Specific fragrance compounds include limonene, linalool, β-phenethyl alcohol, and β-myrcene, for example.

One or more of the bottom wall 20, the top wall 30, the front wall 21, the left wall 22, the right wall 23, and the back wall 24 can be made of two layers. For example, one or more of the bottom wall 20, the top wall 30, the front wall 21, the left wall 22, the right wall 23, and the back wall 24 can comprise an inner layer of paperboard and an outer layer of paperboard that is the same or different specific material than the inner paperboard.

In a preferred embodiment, a coating is applied to the inner liner board of the inner layer, for example prior to lamination. The coating can create a moisture barrier and/or a moisture repellant and thus prevent leakage from the litter box 10. A particularly preferred coating comprises one or more of alcanes C₁₁-C₁₅, but the coating can be any coating that can form a moisture barrier and/or a moisture repellant.

The inner layer can form a back ledge 42 extending farther from the back wall 24 than the back section 32 of the top wall 30. For example, the back ledge 42 can be positioned under the removable strip 35 before the removable strip 35 is detached from the top wall 30.

The litter box 10 can comprise an adhesive strip 41, preferably on the first portion 40a of the first flap 40. Additionally or alternatively, the adhesive strip 41 can be provided on the back section 32 and/or the back ledge 42.

When use of the litter box 10 is completed, the pet owner can remove a cover of the adhesive strip 41 to expose an underlying adhesive (e.g., a hot melt adhesive). The adhesive of the adhesive strip 41 can attach the first portion 40a of the first flap 40 to the back section 32 and/or the back ledge 42 when the first portion 40a is positioned in abutment with the back section 32 and/or the back ledge 42 respectively. The first flap 40 can thereby be sealed in the closed position, sealing the pet litter 100 and animal elimination waste in the litter box 10. Additionally or alternatively, the back side of the first portion 40a of the first flap 40 can be inserted under the back section 32 and/or the back ledge 42 to close the first flap 40 and/or maintain the first flap 40 in the closed position.

After the first flap 40 is closed on the litter box 10, the litter box 10 with the pet litter 100 and animal elimination waste sealed therein can be disposed, for example by placing it in a dumpster or another garbage receptacle. For example, the litter box 10 can be disposed after the adhesive strip 41 is attached to the back section 32 and/or the back ledge 42 to close the first flap 40. Additionally or alternatively, the litter box 10 can be disposed after the back side of the first portion 40a of the first flap 40 is inserted under the back section 32 and/or the back ledge 42 to close the first flap 40.

Another aspect of the present disclosure is a method of managing animal elimination waste. The method can utilize the litter box 10 or any litter box that can fulfill the steps of the method. The method can comprise a pet owner ordering a litter box from a commercial entity, preferably through an e-commerce channel using an internet webpage. The method can comprise the pet owner receiving the litter box with pet litter sealed therein, preferably at their home and preferably from a third party such as a mail carrier and/or a shipping service. Alternatively, the pet owner can purchase the litter box at a retail store.

The method can comprise the pet owner placing the litter box in a desired location, for example a desired location within their home. The litter box can comprise a removable strip connected to a first flap of the litter box, and the pet owner can detach the removable strip to allow the first flap to be folded down along an entry side of the litter box (e.g., the front wall). For example, the detachment of the removable strip can disconnect at least one side of the first flap from the remainder of the litter box.

Then the pet owner can fold the first flap down along the entry side. The first flap can be secured to the entry side by (i) a second flap (e.g., a tuck flap preferably provided by a portion of the first flap) that inserts between the bottom wall of the litter box and the surface on which the box rests and/or (ii) an adhesive on a portion of the first flap that abuts a portion of the entry side of the box. This open position of the first flap can forms an entry mat providing an exposed anti-tracking structure, such as a corrugate fluting structure, which can capture litter granules that may be carried by the feet of a pet during exit from the litter box.

After the pet litter in the litter box has been used one or more times by the pet for elimination, the pet owner can pull the first flap away from the entry side of the litter box and refolds the first flap back to the closed position. For example, the pet owner can attach an adhesive for closing the box that is on the first flap to another section of the box, such as a back section and/or a back ledge of the box, to hold the first flap closed. Additionally or alternatively, the pet owner can tuck a back side of the first flap under a back section and/or a back ledge of the box to hold the first flap closed. The closing of the first flap helps to contain the used pet litter and the animal elimination waste during disposal.

Another aspect of the present disclosure is a method of providing a litter box to a pet owner. The method comprises receiving an order from the pet owner for the litter box, preferably through an e-commerce channel using an internet webpage. The method further comprises providing the litter box with pet litter sealed therein to a third party such as a mail carrier and/or a shipping service for the third party to convey the litter box to the pet owner. The litter box can be the litter box 10 or any litter box that can be employed by a pet owner in the method of managing animal elimination waste disclosed above.

As used herein, the pet litter used in the litter box (e.g., the pet litter 100) can be any substance that can absorb animal urine and/or decrease odor from animal urine and/or feces. Non-limiting examples of suitable substances for litter include clays, woods, agricultural products (including agricultural by-products), silica gels, and combinations thereof. In an embodiment, the litter consists of natural components only and thus does not contain non-naturally occurring components. The term “natural components” includes chemically synthesized substances that are identical in structure to a naturally-occurring form of the substance. In a particularly preferred embodiment, the pet litter has a density of about 25.0 lb/ft³ to about 45.0 lb/ft³, for example about 30.0 lb/ft³ to about 42.0 lb/ft³.

Non-limiting examples of suitable clays include non-swelling clays, swelling clays, and combinations thereof. The clays can be clays that are obtained directly by mining natural clay deposits, synthetic clays, or clays that are derived from the agglomeration of clay particles, e.g., clay particles produced, by litter or other manufacturing processes that involve the use of clays.

Non-swelling clays include kaolinites, illites, ventriculites, attapulgites, sepiolites, and non-swelling smectites. In preferred embodiments, the non-swelling clays are rich in the following clay minerals: palygorskite-sepiolite, kaolinite, dickite, nacrite, illite, glauconite, celadonite, and phengite. Most preferably, the non-swelling clays comprise the clay minerals Ca-montmorillonite, kaolinite, and illite.

Swelling clays include smectites and swelling forms of kaolinites, illites, and vermiculites. In preferred embodiments, the swelling clays contain one or more of hectorite, beidelite, montmorillonite, nontronite, saponite, sauconite, vermiculite, and halloysite. More preferably, the clay is bentonite, e.g., a Na-montmorillonite (Na-bentonite). Generally, bentonite is a naturally occurring combination of clay minerals and some non-clay mineral constituents. Na-bentonite is rich in Na-montmorillonite but may also include other clay and some non-clay mineral constituents. In various embodiments, the swelling clays comprise Na-montmorillonite, hectorite, and vermiculite.

When used in combination, the non-swelling and swelling clays can be mixed in any amount suitable for forming the animal litters. Generally, the non-swelling and swelling clays can be mixed in amounts from about 10 to about 90% non-swelling clay and from about 90 to about 10% swelling clay.

Non-limiting examples of suitable woods include cedar, pine, oak, maple, eucalyptus, aspen, yucca, and combinations thereof. In preferred embodiments, the woods comprise cedar, pine, or combinations thereof. In various embodiments, the pine is New Zealand Pine or Southern Yellow Pine, and the cedar is Western Red Cedar. The woods can have any form suitable for functioning as an animal litter, e.g., chips, particles, pellets, crumbled pellets, or crumbles. In preferred embodiments, the woods are cedar, pine, or a combination thereof.

Non-limiting examples of suitable agricultural products include alfalfa, corn, corn stalk, corn flour, oat hull, oat stalk, oat flour, barley hull, barley meal, barley stalk, barley flour, wheat hull, wheat straw, wheat flour, soybean hull, soybean meal, soybean floor, rye hull, rye meal, rye straw, rye flour, rice straw, rice hull, sorghum straw, sorghum hull, sunflower seeds, and combinations thereof. In some embodiments, the agricultural products comprise plant material, such as bamboo, lemongrass, switchgrass, catnip, oregano, parsley, rosemary, sage, thyme, valerian root, alyssum, chrysanthemum, honeysuckle, hops, lavender, apples, berries, orange peels, orange pulp, sunflower hulls, coffee, tea, or combinations thereof. In other embodiments, the agricultural products comprise sawdust, paper, cellulose, corncob, corn kernel, Distillers Dried Grain (DDG), corn pellet, oaf pellet, barley pellet, wheat middlings, soybean pellet, rye pellet, rice grain, rice pellet, sorghum grain, sorghum pellet, or combinations thereof. In still other embodiments, the agricultural products comprise sunflower seed, almond, pistachio, walnut, pecan, hazelnut, peanut, acorn, wheat middlings, wheat straws, or combinations thereof.

In a preferred embodiment, the agricultural products comprise wood and corncob. In a more preferred embodiment, the agricultural products comprise cedar, pine, and corncob.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A litter box comprising:
a top wall and a bottom wall;
side walls extending between the top wall and the bottom wall such that the top, bottom and side walls form an interior;
pet litter enclosed in the interior; and
a first flap comprising a first portion formed by at least part of the top wall, the first flap arranged in the litter box in a closed position and configured to move to an open position in which the pet litter is accessible, and the first portion of the first flap is approximately coplanar with the bottom wall in the open position.

2. The litter box of claim 1, comprising an anti-tracking structure on the first portion of the first flap, the anti-tracking structure comprising ridges extending upward from the first portion of the first flap in the open position.

3. The litter box of claim 1, comprising a component configured to secure the first flap in the open position, the component selected from the group consisting of (i) an adhesive on a portion of the first flap other than the first portion, (ii) an adhesive on one of the side walls, (iii) a second flap formed by a portion of the first flap other than the first portion, the second flap configured to slide under the bottom wall when the first flap is in the open position, and (iv) combinations thereof.

4. The litter box of claim 1, wherein the first flap is configured to move from the open position back to the closed position in which the pet litter is enclosed in the interior, and the litter box comprises a component configured to secure the first flap back in the closed position, the component selected from the group consisting of (i) an adhesive on the first portion of the first flap, (ii) a section of the top wall under which at least a part of the first portion of the first flap is inserted, and (iii) a combination thereof.

5. The litter box of claim 1, wherein a portion of the first flap other than the first portion is formed by at least part of one of the side walls.

6. The litter box of claim 1, wherein the top wall comprises a section that forms the first portion of the first flap, and the top wall comprises at least one other section that extends inward to form an overhang for the interior of the litter box.

7. The litter box of claim 6, wherein the first portion of the first flap in the closed position is approximately coplanar with the at least one other section of the top wall.

8. The litter box of claim 1, wherein the top wall comprises a removable strip configured to maintain the first flap in the closed position and configured to allow the first flap to fold to the open position after detachment of the removable strip from the remainder of the top wall.

9. The litter box of claim 8, comprising a back ledge underlying the removable strip before the removable strip is detached.

10. The litter box of claim 1, comprising a user-activated malodor counteractant strip positioned in the interior of the litter box.

11. The litter box of claim 1, comprising a moisture-resistant coating applied to at least one component selected from the group consisting of (i) the top wall, (ii) the bottom wall and (iii) one or more of the side walls.

12. A method of managing pet waste, the method comprising:
placing a litter box in a desired location, the litter box comprising a top wall, a bottom wall, and side walls extending between the top wall and the bottom wall such that the top, bottom and side walls form an interior in which pet litter is enclosed; and
moving a first flap of the litter box from a closed position to an open position in which the pet litter is accessible, the first flap comprises a first portion formed by at least part of the top wall, and the moving of the first flap to the open position comprises moving the first portion of the first flap to be approximately coplanar with the bottom wall.

13. The method of claim 12, comprising ordering the litter box using an internet webpage and then receiving the litter box with the pet litter enclosed in the interior of the litter box, and the placing of the litter box in the desired location is performed after receipt of the litter box.

14. The method of claim 12, wherein a removable strip is positioned in the top wall of the litter box to maintain the first flap in the closed position, and the method comprises detaching the removable strip to allow the moving of the first flap from the closed position to the open position.

15. The method of claim 12, comprising securing the first flap in the open position by performing an action selected from the group consisting of (i) inserting a second flap between the bottom wall of the litter box and a surface on which the litter box rests, the second flap formed by a portion of the first flap other than the first portion, (ii) using adhesive to attach one of the side walls to a portion of the first flap other than the first portion, and (iii) a combination thereof.

16. The method of claim 12, wherein the moving of the first flap from the closed position to the open position exposes an anti-tracking structure on the first portion of the flap that captures the pet litter carried by the pet during exit from the litter box.

17. The method of claim 12, comprising moving the first flap back to the closed position after the pet litter has been used by the pet one or more times.

18. The method of claim 17, comprising securing the first flap back in the closed position by performing an action selected from the group consisting of (i) using an adhesive to attach the first portion of the first flap to another section of the litter box; (ii) inserting at least a part of the first portion of the first flap under a section of the top wall, and (iii) a combination thereof.

19. The method of claim 12, wherein the moving of the first flap from the closed position to the open position provides access to a malodor counteractant strip positioned in the interior of the litter box, and the method comprises removing a cover from the strip.

20. A method of providing a litter box, the method comprising:
receiving an order for the litter box from an individual through an internet webpage; and
sending the litter box to the individual with pet litter enclosed in the litter box, the litter box comprising a top wall, a bottom wall, and side walls extending between the top wall and the bottom wall such that the top, bottom and side walls form an interior in which pet litter is enclosed, and the litter box comprises a first flap comprising a first portion formed by at least part of the top wall, the first flap arranged in the litter box in a closed position and configured to move to an open position in which the pet litter is accessible, and the first portion of the first flap is approximately coplanar with the bottom wall in the open position.
